(19) United States
(12) Patent Application Publication
(10) Pub. No.: US 2006/0281635 A1
(43) Pub. Date: Dec. 14, 2006

(54) Method and liquid for increasing the recovery factor in oil reservoirs

(75) Inventors: Antonio Garcia Torres Volpon, Rio de Janeiro (BR); Maria Aparecida de Melo, Rio de Janeiro (BR); Renata da Costa Casella, Cascadura (BR); Ivonete Pereira Gonzalez de Silva, Rio de Janeiro (BR); Heitor Cesar Correia Nicolau, Aracaju (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A. -PETROBRAS, Rio de Janeiro RJ. (BR)

(21) Appl. No.: 11/447,297

(22) Filed: Jun. 6, 2006

(30) Foreign Application Priority Data
Feb. 18, 2005 (BR) PI 0500573-6

(51) Int. Cl. C09K 8/00; E21B 43/00

(52) U.S. Cl. 507/203

(57) ABSTRACT

This invention deals with a method for increasing the recovery factor in oil reservoirs through the injection of polymerization precursor liquids with low viscosity for the production of biopolymers in situ. The method acts in conjunction with the injection profile correction and advanced oil recovery. The invention also refers to the composition of liquids that are precursors of polymerization with low viscosity and to the use of spores or specific bacterium for said purpose. A polymerization precursor liquid is injected into the reservoir which impregnates the rocky matrix. Afterwards, a continuous injection of a polymerizable liquid with additives of low viscosity is performed. The creation of a biopolymer occurs in situ, adhering itself to the rocky matrix, preferably in the thief zones, blocking said zones. A secondary effect of the liquid thickening in productive zones reduces the difference between the viscosity of the water and the viscosity of the oil and acts as a displacement liquid for the oil only in the productive zones. The method according to the present invention is suitable for reclaiming depleted reservoirs with negative pressure, and is viable under offshore conditions

### SCOPE OF THE INVENTION

This invention relates to a method for increasing the recovery factor in oil reservoirs through the injection of polymerization precursor liquids for the production of biopolymers in situ.

The method of operation combines the Injection Profile Correction, in the first stage, and the Advanced Oil Recovery (mobility correction), in the second stage, by using bacteria that produce biopolymers in situ. This method is capable of recovering depleted reservoirs with negative pressure, preferential channeling and extreme porosity.

The invention also refers to the composition of liquids that are precursors of polymerization with low viscosity in order to increase the Recovery Factor in Oil Reservoirs and to the use of spores or specific bacterium for said purpose.

### BACKGROUND OF THE INVENTION

In view of the exhaustion of oil reserves, the greatest challenge to petroleum industry is the ability to provide this energy source and to supply in the future. Many investments have been made in the search for new reserves and to improve current techniques of Advanced Oil Recovery.

In the primary oil recovery, the natural energy of the reservoir is used, however, a large portion of the oil still remains in the formation.

Several methods have been developed to increase the oil recovery from the reservoir, such as water injection (“water flooding”) in secondary recovery and several methods of Advanced Oil Recovery, such as, thermal, miscible and chemical and microbiological methods. In spite of all efforts made, the techniques of oil recovery currently available, in addition to not removing more than 20% of the additional oil from reservoirs, present problems associated with operational difficulties such as thermal losses and the relatively high cost of thermal methods, the difficulty of obtaining the CO₂ used in the miscible methods, the high cost and the degradability of synthetic products used in chemical methods, among others.

Techniques of Advanced Oil Recovery are not recommended for reservoirs with a lot of channeling due to the natural heterogeneous nature of the layers which have varying degrees of permeability. Neither is the secondary recovery action (water injection), due to unfavorable oil/water mobility where the process's secondary injection fluid (water) is preferably distributed into zones of high permeability or “thief zones” in detriment of zones of low permeability, where significant amounts of oil are held.

Thus, some technologies had been developed for the purpose of totally or partially obstructing the thief zones in order to redirect the liquid to zones of low permeability not yet swept by the injection water.

Several materials are used with or for the purpose of controlling the permeability of the formations, such as oil/water emulsions, and chemical products such as gels, silicates, lignosulfonates, polymers, and others.

Polymers, such as polyacrylamides, polysaccharides, cellulose, furfural alcohol and epoxy and acrylic resins, silicates and polyisocyanurates, have been widely studied for this function.

Currently, the available applications in the specialized literature, to correct the Injection Profile, are limited to reservoir operations of modest scope and with no selectivity (SPE-93003, SPE-90390, SPE-84867). On the other hand, Advanced Oil Recovery Methods are not indicated for heterogeneous reservoirs (SPE-65164, SPE-39234, SPE-59308) which makes the process fail. Moreover, the microbiological methods issued at this time, do not give a clear definition of the performance mechanisms of the microorganisms used in a porous medium, which generates difficulties during the stages of definition, sizing and evaluation of the field processes (SPE-89456, SPE-89453, SPE-75238, SPE-79176).

To solve this problem, the Method for Increasing the Recovery Factor in Oil Reservoirs according to this invention, clearly, objectively, and sequentially defines each stage of the process. From the initial conception to the implementation and the optimization of the process in the field, said method involves obtaining the microbiological product, developing and optimizing the performance mechanism of these microorganisms in the laboratory and, from the laboratory data, predicting the fluids to be injected in the reservoir.

This method for increasing the recovery factor in oil reservoirs acts as Injection Profile Correction Process and Advanced Oil Recovery Method (mobility correction) in the reservoir, using bacteria which produce biopolymer in situ.

The described process in the present invention is applied with equivalent success in extremely heterogeneous fields.

The application of conventional methods of Advanced Recovery of Oil is not recommended for extremely heterogeneous reservoirs. Usually a correction of the injection profile is performed before using the advanced oil recovery method with some of the currently available techniques, such as, for example, the polymeric technique. This greatly increases operational difficulties, the risk of failure and the difficulty of method evaluation due to the great number of variables involved.

There has been cited in the literature related to the identification of susceptible bacteria to be used in the Advanced Oil Recovery, by producing bioproducts such as biogas, biopolymers, biosurfactants, biomass, biosolvents, etc., however; the biggest problem to be solved is identifying the performance mechanism of these bioproducts or their partnership and, consequently, the associated process, that is, the application itself and evaluation in the field.

Some patents describe the use of pure polyamides or those related to metal compounds to perform the Injection Profile Correction, the effects of which are temporary when correcting porosity owing to high sensitivity to saline environments. Moreover these are treatments without selectivity and have a short range, that is, the penetration radial are not greater than 10 m from the well. Other patents describe technologies for Injection Profile Corrections using polysaccharides in the presence of polyvalent metal ion exchange agents. Some patents use a certain type of metal compound as cross linker agent. But, in all these cases the problems presented are also the same as described previously: degradability of chemical products, process without selectivity and low penetration.

The method of present invention presents is advantageous over the others through its high reservoir penetration and water zone performance selectivity, combining an intelligent water concept, which has been much sought recently, as oil fields have reached maturity.

Although some patents deal with the process of Advanced Oil Recovery using oil/water mobility correction, that is, increasing the viscosity in the water (displacement phase) to make it equal to the oil viscosity (displacement phase) for the purpose of improving sweep efficiency, these patents use with synthetic polymers such as polyacrilamides or biopolymers, which are both produced on the surface. This presents the great disadvantage of needing a dilution system on the surface and of needing to be injected having already achieved the final required viscosity.

Present patent application, however, describes a method for polymerization in situ that drastically simplifies operational procedure because there is no need of prior dilution and for injecting fluids with low viscosity (near the water viscosity).

The here described patent application, besides being more effective in regards to the methods of Injection Profile Correction and to the conventional methods of Advanced Oil Recovery, independently, offers the great advantage in combining both methods.

As an example of patents applied to the Injection Profile Correction, U.S. Pat. No. 3,908,760 describes a process of water injection/biopolymer in which a water soluble polysaccharide is produced by the Xanthomonas campestris bacteria and later gelled, this being injected into a stratified reservoir in order to form a gel that extends vertically through the layers with both high and low permeability. Said patent also suggests using complex polysaccharides to block the natural or produced fractures. In this case, the biopolymer is produced on the surface, injected and gelled in the zone to be plugged temporarily.

U.S. Pat. No. 4,799,545 (24/01/1989), titled “Bacterium and its uses in the microbial profile modification” describes the application of bacteria (Bacillus licheniformis and Bacillus NRRL B-18178).

An example of patents applied to Advanced Oil Recovery using the mobility correction is the application PI8405610-0 titled “Composition for Use in Improved Oil Recovery, Process to Produce a Xanthomonas Biopolymer Solution and Crude Oil Recovery Process from an Underground Formation Containing Oil”, (currently expired), which describes a composition for use in Advanced Oil Recovery, a process to produce a xanthomonas biopolymer solution and a process for crude oil recovery from an oil bearing underground formation. (U.S. Pat. No. 4,639,322—Biopolymer Having Enhanced Filterability). The use of a xanthomonas biopolymer to recover oil is disclosed. This patent discloses the surfactant property of a biopolymer derived from the Xantomonas bacterium containing 1.5 to 20% xanthomonas and methylene bis-thiocyanate (MTB) with a pH=3.5. In this way, the polymer is also injected from the surface in order to facilitate oil flow.

The bacteria mostly used in traditional processes of Advanced Oil Recovery is the Xanthomonas genre. Said bacteria use carbohydrates to produce a heteropolysaccharide, named Xanthan, on the surface.

The Brazilian publication, PI8403194-8 (06/28/1984) describes a “Process to Prepare Heteropolysaccharide with the use of Xanthomonas Produced on the Surface, Perforation Fluid, Process for Dealing with Exploration of Oil Wells, Process for Displacing Fluid through an Oil Well”.

The Brazilian patent publication PI9503087-5 (07/05/1995) entitled, “Fluid System to Control Fluid Loss during Hydrocarbon Recovery Operations and Process for Protecting Well Bores”, describes a liquid made up of calcium carbonate and a polysaccharide produced from a fungus for the Advanced Oil Recovery.

Brazilian publication PI8004299-6 entitled “Process for the production of biopolymers; mobility control drilling liquid to use in oil recovery; process for this recovery; process for polymerization in suspension and detergent composition” also discloses a biopolymer produced on the surface.

The traditional methods available in the technique show disadvantages in oil recovery in heterogeneous fields with low pressure: thermal methods become impracticable on offshore fileds; methods of CO₂ Injection are hindered by the scarcity of CO₂; chemical methods generate degradation problems, problems due to working in isolated areas and problems with pressure; methods using surfactants and polymers or biopolymers create the need for pre-treating the channeling.

In the majority of the previously described methods, synthetic polymer or biopolymer is pre-produced and injected into the well, being necessary additives for viscosity improvement (chemical agents, metal chelating agents and other agents). In addition to these factors, it is necessary to rigorously control the pH in order to control viscosity. Thus, become critical factors: the reach and the selectivity of the Injection Profile Correction, and the viscosity of the fluid to be injected during Advanced Oil Recovery.

Some patents describe the injection of microorganisms and spores into the reservoir to form bioproducts in situ, however these patents either use the surfactant power of the product, or work with specific microorganisms, that usually are not brought in the native microbe community, as for example: Bacillus licheniformis NRRL B-18178 (U.S. Pat. No. 4,799,545) or Bacillus strain BCI or 47 Bacillus strain or Pseudomonas 1-2 (U.S. Pat. No. 4,558,739).

The bacteria, as well as the above described biopolymers and their culturing methods are not suitable to Advanced Oil Recovery in critical conditions, such as depleted, high porous reservoirs with negative pressure.

The nutrient solutions used in these patents were very concentrated, which decrease the solution's ability for penetration and reach of the injection profile correction.

The method of operation combines the Injection Profile Correction, in the first stage, and the Advanced Oil Recovery (mobility correction), in the second stage, by using bacteria that produce biopolymers in situ. This method is capable of recovering depleted reservoirs with negative pressure, preferential channeling and extreme porosity. This channeling can be naturally heterogeneous or due to unfavorable oil/water mobility, the action of the secondary recovery (water injection) will cause so-called “fingers”.

In the Injection Profile Correction the fluid in question acts selectively and with great penetration using the intelligent water concept, blocking off the high permeability zones, with biomass and biopolymer produced in situ, causing an increase of pressure in the reservoir and redirecting fluids injection (displacement) towards the unwashed or virgin zones. After this, part of the biopolymer produced in the washed zone moves with the water towards the unwashed or virgin zone increasing the swept efficiency of this water as a result of the oil/water mobility correction, that is, the Advanced Oil Recovery.

In this context, the method of oil recovery of present invention has been proven effective for increasing the recovery factor through its application in the field. It is versatile, providing the possibility of its use in homogeneous and heterogeneous reservoirs of various diameters and generates minimal environmental impact, since it is derived from bacteria found in the reservoir itself. The cost of the fluid and the method according to this invention is low when compared to other available methods and fluids. Also, the method is feasable in offshore conditions and presents logistics of simple application and low cost.

The bacterium is facultatively anaerobic, produces spores, is endowed with motility, it is resistant to the saline environment and the temperature of the reservoir, besides producing a stable exo-polymer under such conditions.

Using this method, there is no need for selective isolation of the zones or channels to be blocked with physical methods as is the case of the use of “packers”.

Present invention uses a diluted aqueous solution containing a bacterium that produces mannose as a fluid precursor of polymerization. The bacteria selected from the performance mechanism definition are Bacillus subtilis, Bacillus megaterium, Bacillus pasteurii, Bacillus licheniformis, Bacillus amyloliquefaciens, Bacillus laevolsvticus, their respective spores or a combination of these.

The polymerizable fluid comprises a nutritional solution of sugar containing nitrogen and phosphorus additives. The method itself includes the Injection Profile Correction, that is, making the area uniform before the advance of the water injection through blocking preferential channeling that is naturally selective and long term, and the oil/water Mobility Correction (Advanced Oil Recovery), that is, improved the water viscosity by biopolymer dissolution.

Therefore, the technique needs a method and fluid to increase the recovery factor in oil reservoirs in highly porous and extremely heterogeneous fields, in which none of the conventional methods of Advanced Oil Recovery, currently available, is applied. The method in question must be capable of recovering oil from reservoirs with great variations of permeability, oil with great variations of viscosity, water with great variations of salinity, high temperature gradients and at great depth with an elevated stage of depletion together with negative pressures. This method, in order to Increase the Recovery Factor in Oil Reservoirs, must act jointly within the Injection Profile Correction and Advanced Oil Recovery of (mobility correction) in the reservoir by using biopolymer producing bacteria in situ, without needing to pressurize or selectively isolate zones or channels to be blocked through physical methods or pre-treatment of the channels. The bacterium (and/or spore), which is previously isolated from the reservoir, is facultatively anaerobic, produces spores, is endowed with motility, is resistant to the saline environment and the temperature of the reservoir, ecologically acceptable, besides producing a stable exo-polymer under such conditions. Since it is produced in situ, the biopolymer does not need a dilution system on the surface, because the polymerization precursor liquids injected have low viscosity (similar to water viscosity).

The technique still needs a method for the injection profile correction, which is an operation of unlimited range in the reservoir with high selectivity, following the intelligent water concept. Said method must be feasible for offshore production and in wells of any diameter (also microwells), using a low cost liquid with abundant availability and must create a stable biopolymer, said method, liquid and use of bacterium or spores described and claimed in this patent application.

### SUMMARY

Present invention relates to a Method to Increase the Recovery Factor in Oil Reservoirs, which comprises the Injection Profile Correction and Advanced Oil Recovery.

In the method, a liquid (1), (a polymerization precursor with low viscosity) is injected into the reservoir, followed by impregnation of said liquid (1) into the rocky matrix, preferably in the water zones (or thief zones). Afterwards, a continuous injection of a polymerization precursor liquid made up of low viscosity nutrients is performed. The biopolymer is formed in situ, adhering itself to the rocky matrix, by the polymerization precursor liquid (1) and of the polymerizable liquid with additives (2) preferably in water zones, blocking said zones.

A secondary effect of the liquid thickening in productive zones reduces the difference between the viscosity of the water and the viscosity of the oil and acts as a displacement liquid for the oil only in the productive zones.

The method according to present invention demonstrates the joint performance of the Injection Profile Correction and Advanced Oil Recovery making it suitable for recovering depleted reservoirs with negative pressure and is feasible under offshore conditions.

Present invention demonstrates a polymerization precursor fluid and a polymerizable liquid in addition to the use of bacteria that are facultatively anaerobic, produce spores, are endowed with motility, are resistant to the saline environment and the temperature of the reservoir, bacteria which produce stable exo-polymers under such conditions.

The invention also provides the combination of said bacteria with their spores, to increase the recovery factor in oil reservoirs.

Thus, the present invention demonstrates a Method and Fluid to Increase the Recovery Factor in Oil Reservoirs that is successful in any oil field including highly porous and extremely heterogeneous fields, which none of the conventional methods of Advanced Oil Recovery, currently available, is applicable.

The method of this invention discloses a reduction in the amount of water produced through blocking highly permeable zones and an increase in oil production from the reservoir in function of redirecting the fluids toward the virgin zones, containing primordial oil, in a more efficient manner due to the oil/water mobility correction (Advanced Oil Recovery).

Present invention provides a feasable method for land and offshore production and in wells of any diameter (including microwells), using low cost and abundantly available liquids that create a stable biopolymer.

The present invention also provides an efficient method for the Injection Profile Correction on a long term basis in a reservoir and with high selectivity, without the need of pre-isolation and selectivity in the zones or channels to be plugged.

### DETAILED DESCRIPTION OF THE INVENTION

Present invention increases oil recovery of through the production of a biopolymer in situ. In the first stage it associates the vertical (multi-layers) and areal (preferential channels) Injection Profile Correction, when necessary, and in the second stage, the Advanced Oil Recovery Mobility Correction through viscosification of the injection water redirected toward the unwashed zones.

Initially, the precursor liquid (1), (a polymerization precursor with low viscosity) is injected into the reservoir and impregnated into the rocky matrix, preferably in the water zones (or thief zones).

The polymerization precursor liquid (1) is an aqueous liquid with additives, that includes a spore or bacterium previously isolated from the natural habitat which is capable of producing mannose, and that is facultatively anaerobic, thermo-resistant, gram positive, endowed with motility and sporulated, with a great ability to adsorve and to penetrate.

The bacterium (4) is selected from a group including Bacillus subtilis, Bacillus megaterium, Bacillus pasteurii, Bacillus licheniformis, Bacillus amyloliquefaciens, Bacillus laevolsvticus, or a combination of these.

Afterwards, a continuous injection of the polymerizable liquid (2) containing additives, is performed, that follows the same path traveled by the liquid (1).

The polymerizable liquid (2) containing additives is made up with nutrients of low viscosity and includes a sugar source in an aqueous solution, with additives containing sources of nitrogen and phosphorus. The nutrients present in the liquid (2) are in low concentration, so that the range of penetration into the interior of the oil reservoir is increased.

Slowly the biopolymer is produced in situ from the polymerizable precursor liquid (1), previously adhered to the rocky matrix, and from the polymerizable liquid (2) with additives, which is continually injected up until the production pressure reaches the wished value.

The biopolymer made is a monosaccharide, a polysaccharide or a mixture of these two said biopolymer is derived from a bacteria (4).

The growth of the biopolymer occurs preferably in the areas of the reservoir that are pre-filled with water. Due to the affinity between these liquids, they obstruct said areas and generate an increase of the pressure in the reservoir.

The polymerizable liquid (2) is diverted from the blocked zones and undergoes a secondary effect of thickening due to the formation of the biopolymer, which is directing towards the zones pre-filled with oil (or productive zones).

Due to this thickness, the difference between the viscosity of water and the viscosity of oil is reduced.

Thus, the liquid is capable of displacing the oil held in productive zones that are difficult to reach.

Thus, in the first stage, there are a vertical multi-layer injection profile correction with uniform blocking in channels of various degrees of permeability and heterogeneous areas and the diffusion of the liquids (1) and (2) following an intelligent water principle.

In the second stage an oil/water mobility correction through viscosification of the injection water is performed and, as a consequence, the difference in the viscosity of oil and water is reduced for increasing the efficiency of the sweep.

The oil recovery method here presented is versatile and may be used in homogeneous and heterogeneous reservoirs. It produces a low environmental impact since the bacteria come from the reservoir itself and generate a low cost when compared with other methods. It is also feasible in offshore conditions, due to simple and low cost procedure.

In the invention, from the performance mechanism definition of the bacteria in the laboratory, a method is established that encompasses the Injection Profile Correction, that is, making the blocking uniform in channels with varying degrees of permeability in very heterogeneous zones, and water/oil Mobility Correction, that is, a reduction in the differences between the water and oil viscosity for the purpose of increasing the efficiency of the sweep.

The method is applied at a reservoir temperature, since the microorganism is adapted at this temperature.

The aqueous polymerization precursor liquid (1) migrates preferentially toward the thief zones in the channels.

The adsorption of the polymerization precursor (2) occurs preferentially in the area of the pores of the rocky matrix, thus generating a natural selectivity.

Because it is a liquid with low viscosity, the scope of the injection correction in the thief zones is preferably used when compared to the traditional methods whose scope is much less due to dealing with highly viscous liquids. Thus, there is no limit on the penetration of the polymerization precursor liquid (1) nor on the polymerizable liquid (2) with additives (nutrient solution).

The nutrient solution has a viscosity close to that of water since it includes an aqueous medium containing sugar, a source of nitrogen and phosphorus, following preferentially the same path as the polymerization precursor liquid and the water channels (thief zones) in detriment to the channels of the reservoirs pre-filled with oil.

The polymerization precursor liquid (1) as well as the polymerizable liquid (2) are low concentration and low cost liquids, with perfect selectivity and reach.

The method minimizes the amount of water produced through blocking highly permeable zones and increases oil production from the reservoir in function of redirecting the fluids toward the virgin zones, containing original oil, in a more efficient manner due to the oil/water mobility correction (Advanced Oil Recovery).

### PREFERRED EMBODIMENT OF THE INVENTION

The example of the application of the preferred modality of the present invention demonstrates that the method of the present invention is feasable in extremely porous oil fields.

The method was developed in the laboratory and verified in tests performed in an oil field located in an area chosen for its vertical (multi-layers) and areal heterogeneity (favorable channels among injection and productive wells).

The efficiency evaluation of the method was performed by monitoring the pressure curve of an injection well by the application of a tracer before and after the application of the method, by the flow profile of an injection well and by production data of the area, particularly the NP (oil production) curve versus NP+WP (total production).

The four sets of data showed the success of the method here described.

In the example here described, a bacterium in the target reservoir was initially isolated and identified as having potential to naturally produce a biopolymer through proper use of nutrients (carbon, nitrogen and phosphorus).

Afterwards, bacteria compatibility tests were performed separately under the conditions of unconsolidated rock, water and oil from the target reservoir.

The polymerization precursor liquid (1) used in this specific example was an aqueous solution containing the bacteria Bacillus subtilus and the polymerizable liquid (2) and the nutritive medium used was a dilute aqueous solution containing less than 1% wt of a sugar source additive with nitrogen and phosphorus sources.

The bacteria, Bacillus subtilus, when in contact with the nutrient, under anaerobiosis conditions, penetrates the porous medium continuously and homogeneously and causes the growth and generation of the biopolymer with a consequential increase in pressure.

The analyses of the rock, after the flow test, showed that the bacteria selected have the capacity to penetrate and be adsorbed by the porous medium at different permeability.

In the same way, the nutrient uniformly penetrates continuously into the porous medium. The bacterium in question has a selective actuation, that is, the capacity of the bacterium to selectively block the zones of greatest permeability (“thief zones”) that constitute the preferred path for the water.

Pilot tests were performed on a small scale reservoir model with simulated layers of varying permeability: highly permeable layer saturated only with water simulating the thief zones, and a layer with low permeability saturated with initial oil, simulating the unwashed zones containing initial oil saturation.

The flow test was performed by injecting the liquids into the two layers without selectivity.

A bacterial slug as well as a nutrient slug initially penetrated into the more permeable zones reproducing the path for water.

It was initially observed that the area with greater permeability was blocked, which generated a redistribution of the liquids into the less porous areas allowing the unwashed area saturated with initial oil to be drained.

At the same time, the biopolymer was produced, confirmed through a flow analysis, causing a viscosification of the water generating a correction of mobility between oil/water and consequently a more efficient recovery in the original area with less permeability.

After developing the process based on actuation mechanisms within a porous medium, an increase in scale with pilot size and implementation for production scale in the target field was performed. The selected field includes an area with vertical heterogeneity (multi-layers) and areal (preferential channels between injection and productive wells). A representation of the channels was performed with the use of tracers.

Afterwards, a selected bacterial and nutrient slugs were injected.

These injections were made without selectivity and with all zones open. The natural selectivity of the method in question used for an Injection Profile Correction is one of the most sought after properties and the “intelligent water” concept evolved that preferentially blocks the thief zones and preserves the unwashed zones.

The treated zone showed changes in its oil production profile. Moreover, significant and verified evidence appeared in the flow profiles of the injection well, in the increase of total pressure in the area (at least triple the initial pressure) and in the profiles of the tracers injected before and after the treatment.

1. Method to Increase the Recovery Factor in Oil Reservoirs, characterized by the following stages:
a) injection of a polymerization precursor liquid (1) with low viscosity;
b) impregnation of said liquid (1) in the rocky matrix, preferably in the thief zones;
c) injection of a polymerizable liquid with additives (2) of low viscosity;
d) formation of the biopolymer (3) occurs in situ, adhering itself to the rocky matrix, through the precursor liquid (1) and of the polymerizable liquid with additives (2) preferably in thief zones, blocking said zones;
e) secondary effect of the thickening of the liquid, with a reduction of the difference between the viscosity of the water and the viscosity of the oil and acts as a displacement liquid only in the productive zones.

2. Method to Increase the Recovery Factor in Oil Reservoirs in accordance with claim 1, characterized by its performance together with the Injection Profile Correction and Advanced Oil Recovery.

3. Method to Increase the Recovery Factor in Oil Reservoirs in accordance with claim 1, characterized by the performance of the Injection Profile Correction.

4. Method to Increase the Recovery Factor in Oil Reservoirs in accordance with claim 1, characterized by the performance of the Advanced Oil Recovery.

5. Method in accordance with claim 1, characterized by reclaiming depleted reservoirs with negative pressure.

6. Method in accordance with claim 1, characterized by the polymer and a biopolymer created in situ.

7. Method in accordance with claim 1, characterized by the injection of the polymerizable liquid with additives (2), which is performed continually up to the end of production.

8. Method in accordance with claim 1, characterized by the injection of the polymerizable liquid with additives (2), which is performed intermittently up to the end of production.

9. Method in accordance with claim 1, characterized by the liquid (1) and an aqueous liquid with additives.

10. Method in accordance with claim 1, characterized by the liquid (1) including a microorganism.

11. Method in accordance with claim 1, characterized by the liquid (1) including at least one bacterium (4).

12. Method in accordance with claim 1, characterized by the liquid (1) including spores of at least one bacterium (4).

13. Method in accordance with claim 1, characterized by at least one bacterium (4) which has been previously isolated from the natural habitat present in the rocky matrix.

14. Method in accordance with claim 1, characterized by at least one bacterium (4), which produces mannose, is facultatively anaerobic, thermo-resistant, gram positive, endowed with motility and is sporulated, resistant to saline environments; includes a great power of absorption and penetration and creates a stable biopolymer.

15. Method in accordance with claim 1, characterized by the bacterium (4) which is selected from a group including Bacillus subtilis, Bacillus megaterium, Bacillus pasteurii, Bacillus licheniformis, Bacillus amyloliquefaciens, Bacillus laevolsvticus, or the combination of these.

16. Method in accordance with claim 1, characterized by a polymerizable liquid with additives (2) that includes a sugar source.

17. Method in accordance with claim 1, characterized by a polymerizable liquid with additives (2), which includes low viscosity in order to increase the depth of penetration into the interior of the oil reservoir.

18. Method in accordance with claim 1, characterized by the polymer created which is a monosaccharide, a polysaccharide or a mixture of these derived from the bacterium (4).

19. Method in accordance with claim 1, characterized by the first stage including:
vertical injection profile correction in multi-tiers with a uniform blockage of the channels of different permeability in very heterogeneous zones.
injection profile correction on-shore in preferential channels,
diffusion of the liquids (1) and (2) following an intelligent water concept.

20. Method in accordance with claim 1, characterized by the second stage including the oil/water mobility correction through the viscosification of the injection water and consequently a reduction in the difference in viscosity between water and oil, and an increase in the efficiency of the sweep.

21. Method in accordance with claim 1, characterized by being viable for oil production on land and in ocean offshore, and may be used in wells of any diameter, including microwells.

22. Method in accordance with claim 1, characterized by logistics of simple application.

23. Method in accordance with claim 1, characterized by versatility and applicable to both homogeneous and heterogeneous reservoirs.

24. Method in accordance with claim 1, characterized by low environmental impact.

25. Method in accordance with claim 1, characterized by dispensing with the use of sophisticated and high cost equipment.

26. Use of the bacterium Bacillus subtilus or its spores, to increase the recovery factor in oil reservoirs, in accordance with claim 1.

27. Use of the bacterium Bacillus megaterium or its spores, to increase the recovery factor in oil reservoirs, in accordance with claim 1.

28. Use of the bacterium Bacillus pasteurii or its spores, to increase the recovery factor in oil reservoirs, in accordance with claim 1.

29. Use of the bacterium Bacillus licheniformis or its spores, to increase the recovery factor in oil reservoirs, in accordance with claim 1.

30. Use of the bacterium Bacillus amyoliquofaciens or its spores, to increase the recovery factor in oil reservoirs, in accordance with claim 1.

31. Use of the bacterium Bacillus laevolsvticus or its spores, to increase the recovery factor in oil reservoirs, in accordance with claim 1.

32. Use of the combination of the bacteria Bacillus laevolsvticus, Bacillus amyoliquofaciens, Bacillus licheniformis, Bacillus licheniformis, Bacillus pasteurii, and its spores, to increase the recovery factor in oil reservoirs, in accordance with claim 1.

33. Polymerization precursor liquid (1) characterized by including a bacterium or its spores useful for performing the method in accordance with claim 1.

34. Polymerization precursor liquid (1) in accordance with claim 31, characterized by including a bacterium or its spores diluted in an aqueous solution.

35. Polymerizable liquid with additives (2) characterized by including a sugar source diluted in an aqueous solution and useful for performing the method in accordance with claim 1.

36. Polymerizable liquid with additives (2), in accordance with claim 35, characterized by including a sugar source diluted in an aqueous solution in the proportion of between 1% and 0.0001% (by mass).

37. Polymerizable liquid with additives (2), in accordance with claim 35, characterized by including a source of nitrogen.

38. Polymerizable liquid with additives (2), in accordance with claim 35, characterized by including a source of phosphorus.
